(19) United States
(12) Patent Application Publication
(10) Pub. No.: US 2004/0141249 A1
(43) Pub. Date: Jul. 22, 2004

(54) Sleep switch device for an audio cassette player

(76) Inventor: Arthur S. Friedman, Merrick, NY (US)

Correspondence Address: DENNISON, SCHULTZ, DOUGHERTY & MACDONALD, 1727 KING STREET, SUITE 105, ALEXANDRIA, VA, 22314, US

(21) Appl. No.: 10/347,346

(22) Filed: Jan. 21, 2003

(51) Int. Cl. G11B 15/18; G11B 17/00; G11B 19/02

(52) U.S. Cl. 360/69

(57) ABSTRACT

A device for personal entertainment equipment incorporates a spring-loaded sleep switch unit, on/off bypass switch and power supply, wherein the source equipment is turned off as soon as the user falls asleep or otherwise relaxes grip on the sleep switch unit.

### BACKGROUND OF THE INVENTION

1. Field of the Invention

The present invention relates to a sleep switch device for an audio cassette player or other personal entertainment equipment.

2. Background of the Invention

Audio cassette players may be manufactured with a “sleep timer” integrated within the equipment's electronic circuitry which operates to automatically turn off the player when a predetermined length of time has elapsed so that the player is not left turned on after the user falls asleep.

Conventional electronic sleep timers have a plurality of time settings of predetermined lengths, for example, 90, 60 and 30 minutes.

When a user wishes to enjoy a music tape in bed until falling asleep, this type of timer must be set to 60 minutes if the required time for reproducing the audio information in the tape is, for example, 45 minutes. In this case, the cassette player remains turned on for some time after the reproduction of the music tape has completed.

However, should the user fall asleep before the end of the audiotape or before the 60 minutes have elapsed, the audiotape will continue to play and the user must then undertake a tedious and time consuming search to find the precise point at which the audiotape was playing when the user fell asleep.

Moreover, battery power will be wasted as the cassette player continues to play while the user is asleep, and also while the user, upon waking, attempts to find the precise point on the audiotape at which to resume listening.

Many of the cassette players on the market today, however, do not possess integrated sleep timer circuitry, in which case the cassette player continues to play until the end of the audiotape is reached if the user falls asleep.

This necessitates the user undertaking a tedious and time consuming search to find the precise point at which the audiotape was playing when the user fell asleep, as well as a needless waste of battery power.

Therefore, it can be appreciated that there exists a continuing need for a practical and economical device that enables a user of an audio cassette player to resume listening to an audiotape from the point at which the tape stopped if the user falls asleep, and also to save battery life. In this regard, the present invention substantially fulfills this need.

### SUMMARY OF THE INVENTION

An object of the present invention is to provide a device for use with an audio cassette player, whereby the device automatically turns off the player if the user falls asleep while listening to an audiotape. This allows the user to easily resume listening to the audiotape from the point at which the tape stopped when the user fell asleep.

Another object of the invention is to provide a device as generally described above, wherein the sleep switch component of the device comprises an on/off bypass that may be used as a simple remote on/off switch to enable the user to stop the cassette player when changing an audiotape or to answer the telephone, for example.

In another embodiment of the invention, the device further comprises a polarity switch serially connected between the battery case and the interchangeable plug.

The battery case accommodates a battery holder carrying two 1.5 volt or AA batteries. A power supply is necessary because once the plug means of the invention is inserted within the 3 volt external socket of the audio cassette player, the batteries located within the players own battery compartment will be bypassed. Thus, optionally, the pair of batteries from the player may be inserted into the battery case of the invention, thus minimizing cost. Preferably, the rear of the battery case is closed by a removable rear wall that is seated within recesses defined in the four side walls of the battery case.

A terminal socket connected to the battery case is adapted to receive standard interchangeable plugs of various sizes. The interchangeable plugs are well known by those of ordinary skill in the art.

### BRIEF DESCRIPTION OF THE FIGURES

The invention will be better understood and objects other than those set forth above will become apparent when consideration is given to the following detailed description thereof. Such description makes reference to the annexed drawings wherein:

FIG. 1 is a perspective view of the device of the invention.

FIG. 2 is a side elevation view of the sleep switch unit.

FIG. 3 is a perspective view of another embodiment of the invention showing the polarity switch.

FIG. 4 is a circuit diagram of another embodiment of the invention.

FIG. 5 is a circuit diagram of another embodiment of the invention.

### DESCRIPTION OF THE PREFERRED EMBODIMENTS

The operation of an embodiment of the present invention will now be described with respect to an audio cassette player used as source equipment. The player necessarily comprises an external (3 volt) jack or socket for connection to an external (3 volt) power supply. Typically, when a compatible plug is inserted within the external jack or socket of the source equipment, the internal batteries of the source equipment are bypassed.

The sleep switch device of the invention comprises (i) a spring-loaded sleep switch unit that includes an on/off bypass switch; (ii) a battery case connected to said sleep switch; and (iii) an interchangeable plug connected to said battery case.

The sleep switch device in a preferred form includes a sleep switch unit 1, an elongate battery case 2, and a terminal socket 3 that is adapted to receive a connector 4 of various sizes. The connector 4 is adapted to be received within an external 3 volt jack of the cassette player or other source equipment 5.

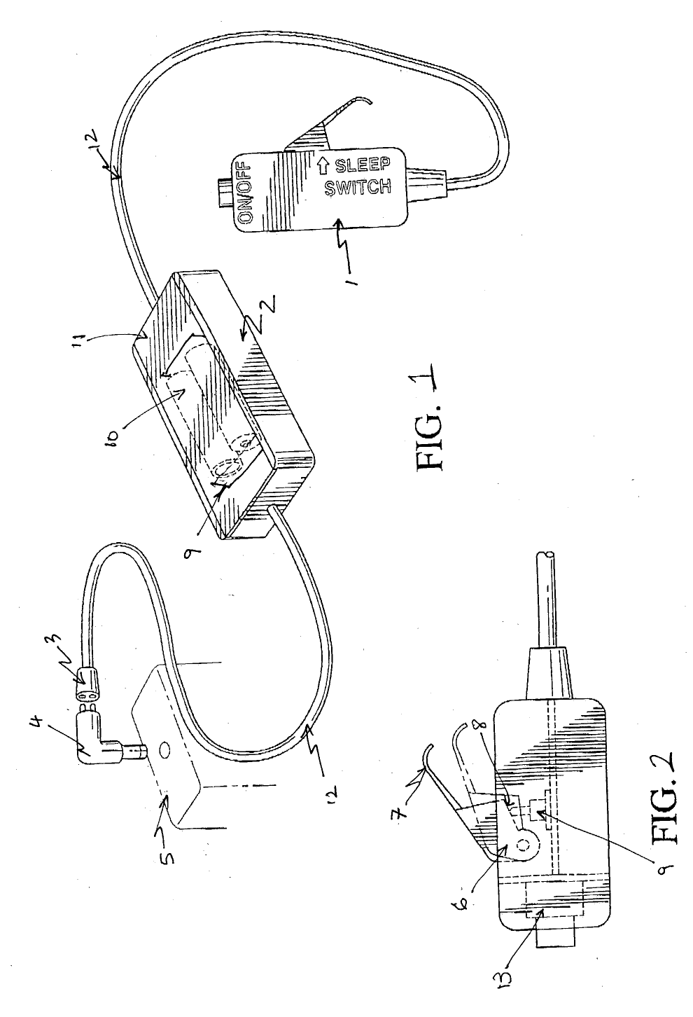

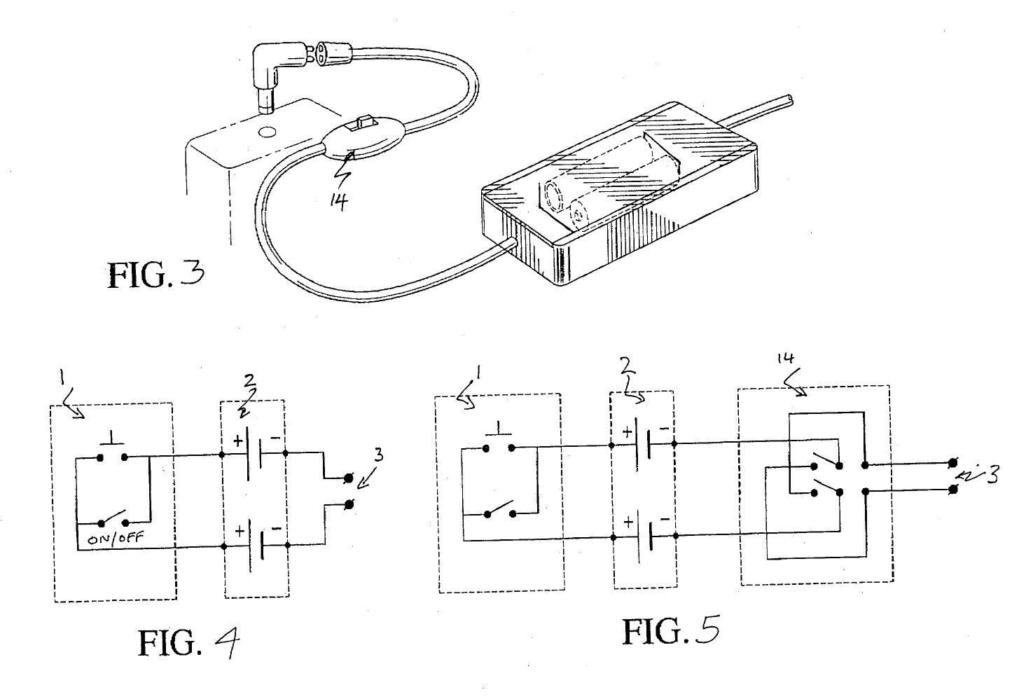

The sleep switch unit 1 is defined by four sidewalls, a bottom wall and a top wall, and includes a lever assembly 6 pivotally connected between two of the opposed sidewalls (FIG. 2). The lever includes an extended arm 7 and a base portion 8, said lever being operable between first and second positions.

In a first “up” position, the base portion 8 of the lever assembly 6 contacts with a spring biased sleep on/off switch 9.

In this position, the circuit between the batteries and the cassette player is interrupted. When force is applied to the lever it pivots to a second “down” position, whereby the base of the lever causes the spring-biased on/off switch 9 to move to an “on” position, thereby completing the circuit between the batteries and the cassette player. When the lever arm 7 is released, the bias force in the spring of the on/off switch allows the lever to pivot back to a first “off” position, thereby again interrupting the circuit between the batteries and the cassette player.

The sleep switch unit (FIG. 2) further includes a spring-biased master on/off switch 13 which when pressed by the user locks into an “on” position completing a circuit between the batteries and the cassette player. When the master on/off switch is pressed a second time by the user, the bias force in the spring allows the switch to return to an “off” position, thereby interrupting the circuit between the batteries and the cassette player, which as a result will stop. In order for the sleep on/off switch to be functional, the master on/off switch must be in its “off” position, thus allowing the user to activate the cassette player by applying pressure to the lever 6 to complete the circuit between the batteries and cassette player.

The battery case 2 is defined by four side walls and a bottom wall, and is of a size to snuggly receive a battery holder 9 that mounts a pair of 1.5 volt or AA batteries 10. The top of the battery case is closed by a removable wall 11 that is seated within recesses defined in the four side walls of the battery case.

It should be understood that the battery case and sleep switch unit is desirably constructed from a thermoplastic material. The thermoplastic material used may comprise, for example, halogen-containing polymers, polyesters, polyolefins, polyamides or acrylnitrile copolymers, and such thermoplastic materials are well known by those of ordinary skill in the art.

The interchangeable plug 3 is adapted to receive standard jacks 4 of various sizes, which are commonly used with audio cassette players.

Standard two-core electrical wire 12 is used to connect the power supply to the sleep switch unit 2, and the power supply to the interchangeable plug 4.

FIG. 4 illustrates the circuit diagram of the preferred embodiment of the invention showing the electrical connections between the sleep switch unit 1, interchangeable plug 3 and battery unit 2.

FIGS. 3 and 5 illustrate another embodiment of the invention wherein a polarity switch 14 is disposed between the battery case 2 and the interchangeable plug 4. The polarity switch reverses the power polarity of the device using a simple switch mechanism, allowing the device to be used with audio cassette players having either a (+) or (−) polarity.

To operate the sleep switch device, the user initially places the on/off bypass switch in the “on” position, thus ensuring a flow of current from the batteries to the cassette player.

Subsequently, the user selects an audiotape, inserts the audiotape into the cassette player, and initiates playback of the tape on the cassette player. After selecting a desirable listening position, the user places the on/off bypass switch in the “off” position and depresses and holds the spring-loaded sleep switch in the “on” (down) position. In this way, current flows from the batteries to the player only as long as the spring-loaded sleep switch is held in the “on” (down) position by the user.

If the user falls asleep, the user's hand holding the spring-loaded sleep switch will relax causing the switch to automatically spring back to the “off” position, and the circuit between the batteries and cassette player to be interrupted. As a consequence, the cassette player will stop.

Upon waking, the user merely depresses the spring-loaded sleep switch once more to restart the cassette player and is thus able to resume listening to the audiotape from the position at which the tape stopped when the user fell asleep.

While the above-described embodiment has been described with respect to an audio cassette player, the present invention may also be applied to a variety of source equipment such as compact disc players, mini-disc players, radios, combined radio/compact disc players, MP3 players, and the like.

As to the manner of usage and operation of the present invention, the same should be apparent from the above description. Accordingly, no further discussion relating to the manner of usage and operation will be provided.

The foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed and desired to be secured by Letters Patent is:

1. A device for personal entertainment equipment, said device comprising:
a sleep switch unit comprising a spring-loaded sleep switch and an on/off bypass switch;
a power supply means connected to said sleep switch unit; and
an interchangeable plug connected to said power supply means.

2. A device according to claim 1, further comprising a polarity switch disposed between the power supply means and the interchangeable plug.

3. A device according to claim 1 wherein the power supply means is a pair of AA batteries.
